(19) United States
(12) Patent Application Publication
(10) Pub. No.: US 2002/0088314 A1
(43) Pub. Date: Jul. 11, 2002

(54) Radius wrench handle

(76) Inventor: Myron Wambem, Lakewood, WA (US)

Correspondence Address: Richard C. Litman, LITMAN LAW OFFICES, LTD., P. O. Box 15035, Arlington, VA, 22215, US

(21) Appl. No.: 09/757,483

(22) Filed: Jan. 11, 2001

(51) Int. Cl. B25B 13/00

(52) U.S. Cl. 81/125.1

(57) ABSTRACT

A radius wrench handle comprises a metal bar having an arcuate configuration. A wrench is adapted to be removably positioned on at least one end of the metal bar. The arcuate configuration of the handle permits the wrench to be utilized to tighten or loosen hard to reach bolts on water or sewer pipes.

### BACKGROUND OF THE INVENTION

1. Field of the Invention

The present invention generally relates to hand tools. More specifically, the present invention is drawn to a radius wrench handle especially adapted for use with large, difficult to access water mains and the like.

2. Description of the Related Art

Repairing and/or replacing sewer and water pipes is often difficult in that the pipes must be uncovered and the repair and/or replacement work must be accomplished in a narrow ditch. The confines of the narrow ditch greatly inhibit the use of pipe wrenches having handles of conventional length and design. Prior art specialty wrenches are usually for automotive application, and are generally too small to produce the leverage that is required when working with pipes of the sizes utilized for water and/or sewerage flow. A tool that would enhance work efficiency would certainly be a welcome addition in the art.

Examples of prior art wrenches of arcuate configuration are shown in U.S. Pat. Nos. Des. 257,319 (Cremer), Des. 340,175 (Mann), Des. 389,710 (Baber), 2,725,773 (Anacker) and 5,996,453 (Blacklock). All of the aforementioned patents are designed for tasks much smaller in size than the tasks contemplated to be performed by the instant invention.

U.S. Pat. No. Des. 411,945 (Chen) shows a compound wrench having offset ends. This design does not lend itself to the task of assembling/disassembling water mains in that the wrench is not long enough to attain effective leverage.

U.S. Pat. No. 4,276,791 (Thompson) shows an offset ratchet wrench. Like Chen above, the instant wrench is not long enough to attain an effective amount of leverage.

U.S. Pat. No. 574,751 (Newman) discloses an arcuate-shaped handlebar grip. The patentee does not consider utilizing the device as a pipe wrench.

U.S. Pat. No. 1,378,209 (Bergman) discloses a conventional, open-ended, adjustable wrench. As indicated above, such wrenches are very difficult to use in water main/sewer replacement and repair.

U.S. Pat. Nos. 3,203,285 (Schmidt), 4,730,960 (Lewis et al.), and 5,455,997 (Nasiell) disclose flexible wrenches. These wrenches lack the ruggedness necessary for consistent application in water main/sewer replacement and repair.

U.S. Pat. No. 5,732,605 (Mann) shows an arcuate wrench which has a complex gear mechanism. Besides being of small size, the wrench of the instant patent appears to be too fragile for the contemplated task of the present invention.

U.S. Pat. No. 5,797,300 (Fairbanks) discloses a collapsible lug wrench.

None of the above inventions and patents, taken either singularly or in combination, is seen to disclose a radius handle wrench as will be subsequently described and claimed in the instant invention.

### SUMMARY OF THE INVENTION

The present invention is drawn to a hand tool designed to be of special utility when employed to repair and/or replace water and sewer pipes. The invention comprises a radius handle which incorporates a wrench at one or both ends. The wrench(s) can be any of the conventional ratchet type commonly utilized in the art. A second embodiment of the invention employs a unique six-point connection for a socket which allows the radius handle to assume a forty-five degree angle relative to the socket. The novel handle enhances the ability of a user to tighten or loosen bolts on water/sewer pipes which are located in ditch lines and similar hard to reach areas.

Accordingly, it is a principal object of the invention to provide a tool for improving working efficiency when applied to water and sewer line pipes.

It is another object of the invention to provide a tool to tighten and loosen bolts on water and sewer line fittings.

It is a further object of the invention to provide a tool having a handle, which handle is adapted to incorporate a conventional wrench at one or both ends thereof.

Still another object of the invention is to provide a tool having a handle, which handle has a unique connection for a socket at one end thereof.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a radius wrench handle according to the present invention.

FIG. 2 is a front view of a first embodiment of a radius wrench handle according to the present invention.

FIG. 3 is a front view of a second embodiment of a radius wrench handle according to the present invention.

FIG. 4 is a partial end view of the embodiment of FIG. 3.

Similar reference characters denote corresponding features consistently throughout the attached drawings.

### DETAILED DESCRIPTION OF THE PREFERRED EMBODIMENTS

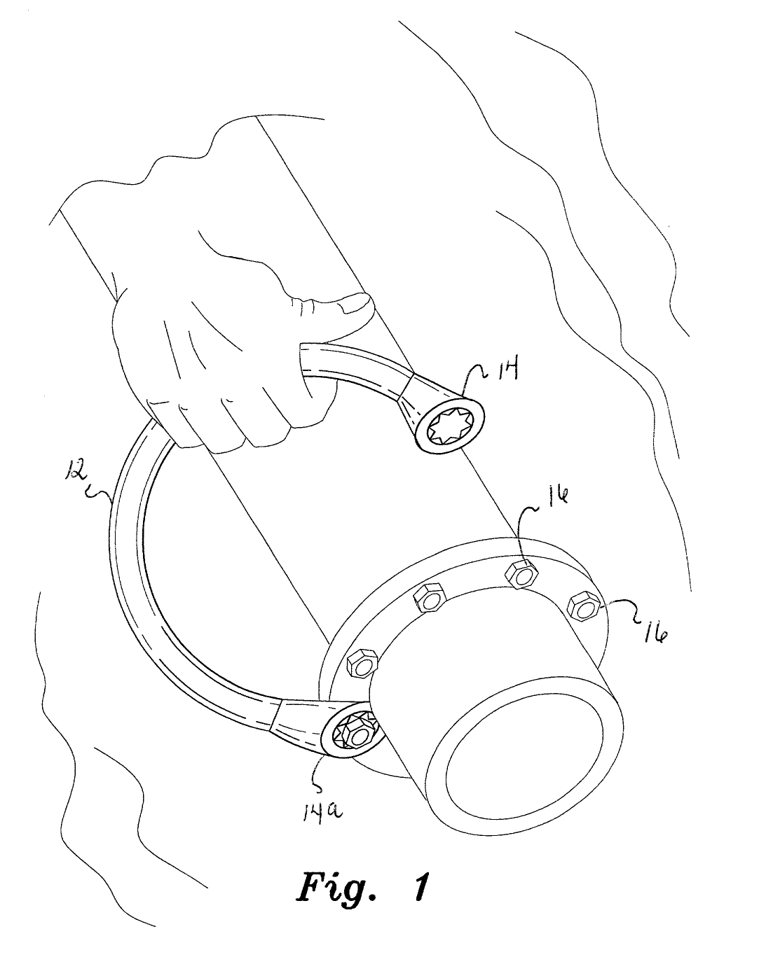

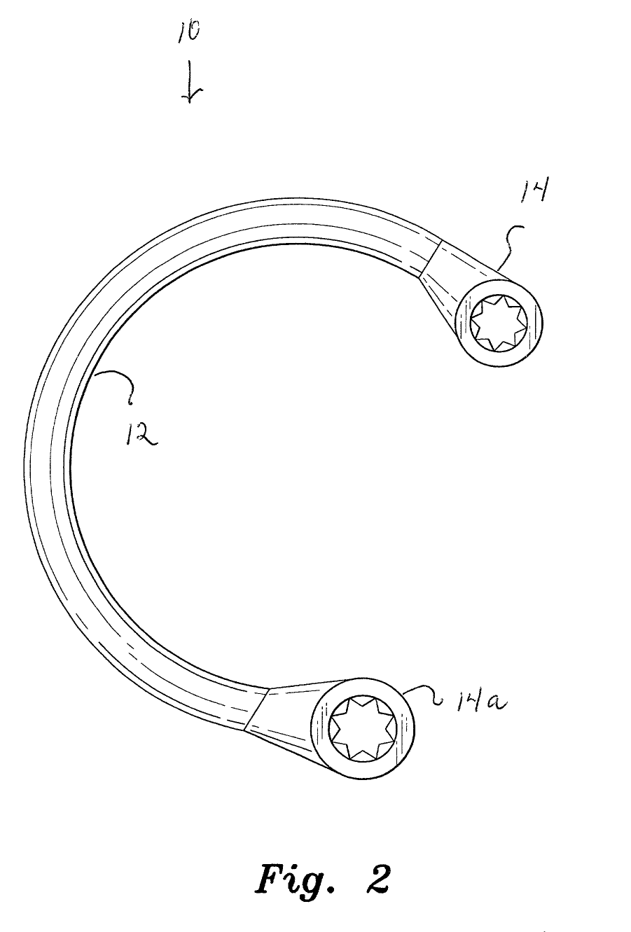

Attention is directed to FIG. 2 which best illustrates a first embodiment of the tool of the instant invention. The tool is generally indicated at 10 and comprises an arcuate handle 12. Handle 12 is fabricated from strong rugged material (forged steel or the like) known in the tool making art. Conventional ratchet heads 14, 14a are disposed at either end of handle 12. Heads 14, 14a are removably attached in any suitable and convenient manner to provide easy replacement of other type and/or size heads. For best results in the contemplated work environment, it has been determined that handle 12 should have a radius of curvature of at least four inches. The length of the handle may vary, dependent on intended use. As shown in FIG. 1, the radius handle 12 allows the user to engage bolts 16 on pipe fittings, which bolts 16 would be difficult to access with a conventional, straight pipe wrench. The arcuate configuration of the handle also maximizes the application of leverage, thereby enhancing bolt tightening and loosening.

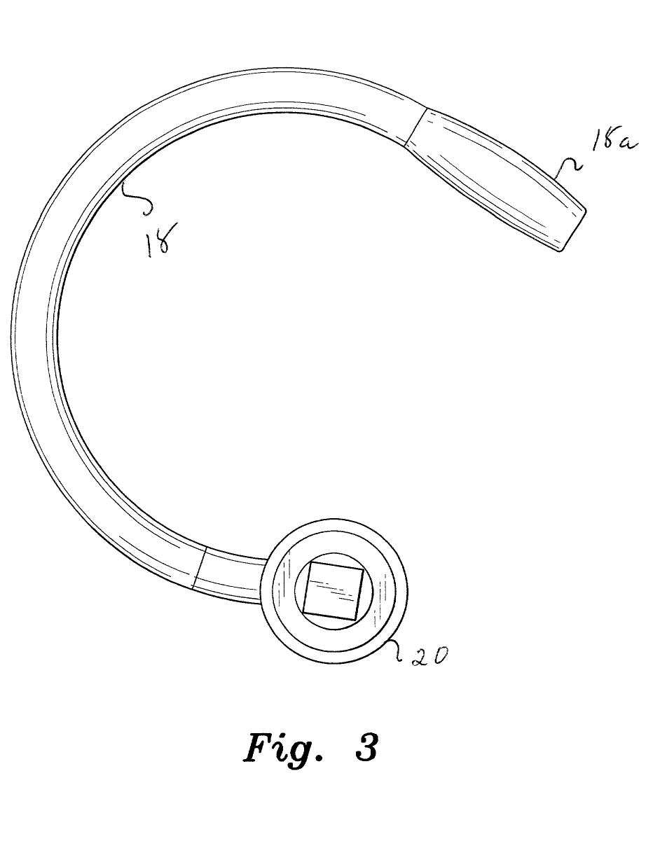

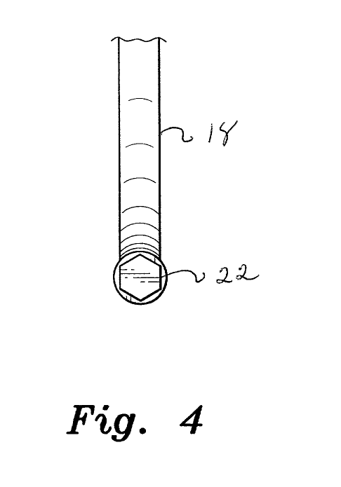

As illustrated in FIGS. 3 and 4, a second embodiment of the invention incorporates an arcuate handle 18 having a removable socket head 20 positioned on one end. The other end 18a of handle 18 is fashioned as a gripping area. As in the first embodiment, handle 18 must have a radius of curvature of at least four inches. A unique feature of the second embodiment is best seen in FIG. 4 wherein and end view of handle 18 is shown with socket head 20 removed. It is noted that male fitting 22 is configured in a hexagonal shape (six point system) rather than the square shape (four point system) of conventional socket fittings. It is obvious that socket head 20 would be designed with a complimentary hexagonal female fitting. The male/female configuration could be reversed if desired. The utilization of a hexagonal (six point system) fitting permits the socket head to be adjusted at a forty-five and ninety degree angles as opposed to only the ninety degree angle of the four point system.

It is to be understood that the present invention is not limited to the embodiments described above, but encompasses any and all embodiments within the scope of the following claims.

I claim:

1. A radius wrench handle comprising:
an arcuate metal bar, said arcuate metal bar having a first end and a second end;
said bar being configured with a radius of curvature;
said radius of curvature being at least four inches; and
a first wrench;
means for removably positioning said first wrench on said first end of said arcuate metal bar.

2. A radius wrench handle as defined in claim 1, including a second wrench;
means for removably positioning said second wrench on said second end of said arcuate metal bar.

3. A radius wrench handle as defined in claim 2, wherein said first wrench is a ratchet wrench.

4. A radius wrench handle as defined in claim 3, wherein said second wrench is a ratchet wrench.

5. A radius wrench handle comprising:
an arcuate metal bar, said arcuate metal bar having a first end and a second end;
said bar being configured with a radius of curvature;
said radius of curvature being at least four inches; and
means for removably positioning a wrench on said first end of said arcuate metal bar.

6. A radius wrench handle as recited in claim 5, wherein said first end of said arcuate metal bar is defined as a male member of hexagonal configuration.

7. A radius wrench handle as recited in claim 6, wherein said means for removably positioning is a socket head having a recessed portion of hexagonal configuration, whereby said socket head is adapted to be positioned on said male member.

8. A radius wrench handle as recited in claim 7, wherein said second end of said elongate metal bar is defined by a gripping area.
